(19) United States
(12) Patent Application Publication
(10) Pub. No.: US 2026/0348128 A1
(43) Pub. Date: Nov. 5, 2026

(54) ELECTRIC WORK MACHINE

(71) Applicant: KOMATSU LTD., Tokyo (JP)

(72) Inventors: Masaki DAIMON, Tokyo (JP); Yuki TAKASE, Tokyo (JP)

(21) Appl. No.: 19/485,694

(22) PCT Filed: Jun. 17, 2024
(86) PCT No.: PCT/JP2024/021894

§ 371 Date: Nov. 19, 2025

(30) Foreign Application Priority Data
Jul. 20, 2023 (JP) 2023-118233

(51) Int. Cl. E02F 9/08

(52) U.S. Cl. CPC E02F 9/0866; E02F 9/0883

(57) ABSTRACT

An electric work machine includes a lower traveling body, an upper revolving body that revolves relative to the lower traveling body, a hydraulic pump that discharges hydraulic oil, an electric motor that drives the hydraulic pump, and a hydraulic oil tank that supplies hydraulic oil to the hydraulic pump. The hydraulic pump, the electric motor, and the hydraulic oil tank are disposed on a side end portion of the upper revolving body. The electric motor is disposed in front of the hydraulic pump and behind the hydraulic oil tank.

### TECHNICAL FIELD

The present disclosure relates to an electric work machine.

### BACKGROUND ART

Patent Document 1 discloses an electric excavator as one example of an electric work machine. The electric excavator includes an electric motor driven with electrical power stored in a battery device. The electric motor drives a hydraulic pump used to supply pressurized oil to a hydraulic pressure cylinder of the work implement.

### CITATION LIST

### Patent Literature

Patent Document 1: JP 2020-045630 A

### SUMMARY OF INVENTION

### Technical Problem

In Patent Document 1, the electric motor is disposed behind the hydraulic pump, and is disposed at a left rear end portion of the upper revolving body. Thus, in a case where, during rightward revolution, an obstacle comes into contact with the left rear end portion of the upper revolving body, there is a possibility that the electric motor disposed at the left rear end portion of the upper revolving body is affected.

An object of the present disclosure is to provide an electric work machine that makes it possible to protect an electric motor.

### Solution to Problem

An electric work machine according to the present disclosure includes: a lower traveling body; an upper revolving body configured to revolve relative to the lower traveling body; a hydraulic pump configured to discharge hydraulic oil; an electric motor configured to drive the hydraulic pump; and a hydraulic oil tank configured to supply hydraulic oil to the hydraulic pump. The hydraulic pump, the electric motor, and the hydraulic oil tank are disposed on a side end portion of the upper revolving body. The electric motor is disposed in front of the hydraulic pump and behind the hydraulic oil tank.

### Advantageous Effects of Invention

With the present disclosure, it is possible to provide an electric work machine that makes it possible to protect an electric motor.

### BRIEF DESCRIPTION OF DRAWINGS

FIG. 1 is a perspective view illustrating an electric excavator according to the embodiment.

FIG. 2 is a perspective view illustrating an internal configuration of a vehicle body cover according to the embodiment.

FIG. 3 is a side view illustrating the internal configuration of the vehicle body cover according to the embodiment.

FIG. 4 is a plan view illustrating the internal configuration of the vehicle body cover according to the embodiment.

### DESCRIPTION OF EMBODIMENTS

### Electric Excavator 1

The configuration of an electric excavator 1 (one example of an “electric work machine”) according to the present embodiment will be described with reference to the drawings.

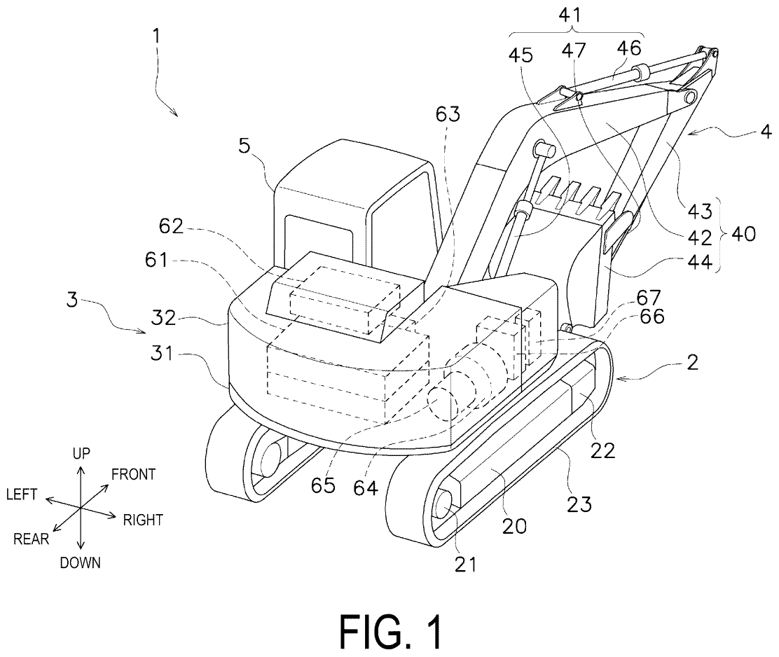

FIG. 1 is a perspective view of the electric excavator 1 as viewed from the right rearward direction.

In the present specification, the terms “up” and “down” mean the upward and the downward with the vertical direction being the reference. In addition, the terms “front” and “rear” mean the frontward and the rearward with the reference being a direction in which the electric excavator 1 travels. Furthermore, the terms “left” and “right” mean the leftward and the rightward when the electric excavator 1 faces the frontward.

As illustrated in FIG. 1, the electric excavator 1 includes a lower traveling body 2, an upper revolving body 3, a work implement unit 4, and a cab 5.

The lower traveling body 2 includes a truck frame 20, a driving wheel 21, a driven wheel 22, and a crawler 23. The truck frame 20 extends in a front-rear direction. The driving wheel 21 is supported by a rear end portion of the truck frame 20. The driven wheel 22 is supported by a front end portion of the truck frame 20. The crawler 23 is looped over the driving wheel 21 and the driven wheel 22.

The upper revolving body 3 is disposed at the upper side of the lower traveling body 2. The upper revolving body 3 is able to revolve relative to the lower traveling body 2. The upper revolving body 3 includes a revolving frame 31 and a vehicle body cover 32.

The revolving frame 31 is formed into a plate shape expanding in the horizontal direction. The revolving frame 31 is supported by the lower traveling body 2. The revolving frame 31 is able to revolve relative to the lower traveling body 2.

The vehicle body cover 32 covers a space above the revolving frame 31. The vehicle body cover 32 is comprised of a plate-shape member. The vehicle body cover 32 accommodates, therein, a battery device 61, a battery-temperature management system (BTMS) 62, an inverter 63, an electric motor 64, a hydraulic pump 65, a hydraulic oil tank 66, a hydraulic valve 67, and the like.

As illustrated in FIG. 1, the hydraulic pump 65, the electric motor 64, and the hydraulic oil tank 66 are disposed at an opposite side from the cab 5 in the vehicle width direction. The hydraulic pump 65, the electric motor 64, and the hydraulic oil tank 66 are arranged in this order from the rear side. The internal configuration of the vehicle body cover 32 will be described later.

The work implement unit 4 includes a work implement 40 and a work-implement driving unit 41. The work implement 40 includes a boom 42, an arm 43, and a bucket 44. The work-implement driving unit 41 includes a boom cylinder 45, an arm cylinder 46, and a bucket cylinder 47. The boom cylinder 45, the arm cylinder 46, and the bucket cylinder 47 operate with hydraulic oil supplied from the hydraulic valve 67.

The cab 5 is disposed on a left front end portion of the revolving frame 31. Various types of operation members and the like are disposed in the cab 5.

### Internal Configuration of Vehicle Body Cover 32

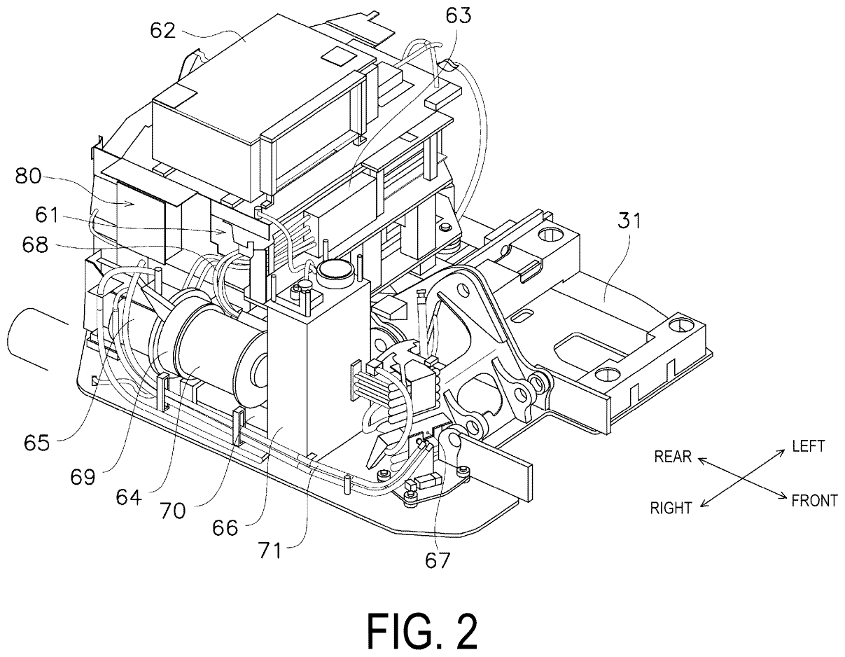

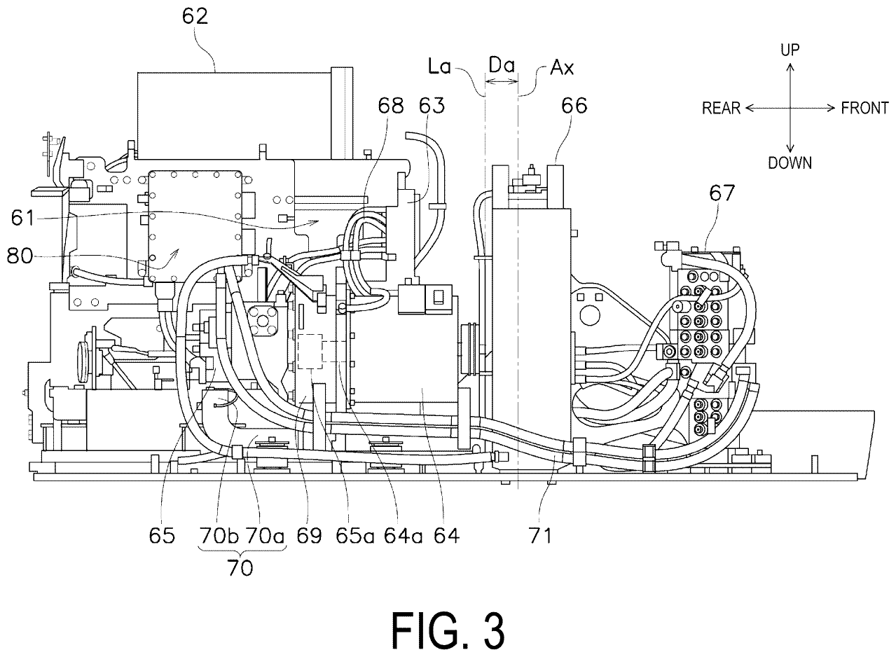

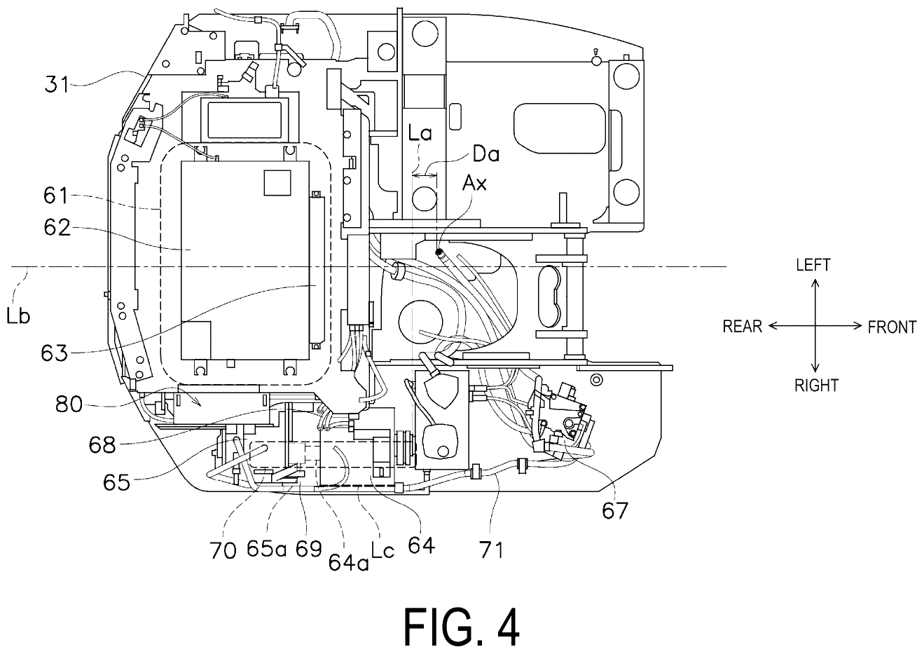

FIG. 2 is a perspective view illustrating the internal configuration of the vehicle body cover 32 as viewed from the right front direction. FIG. 3 is a side view illustrating the internal configuration of the vehicle body cover 32 as viewed from the right side. FIG. 4 is a plan view illustrating the internal configuration of the vehicle body cover 32 as viewed from the above.

The vehicle body cover 32 accommodates, therein, the battery device 61, the BTMS 62, the inverter 63, the electric motor 64, the hydraulic pump 65, the hydraulic oil tank 66, and the hydraulic valve 67.

The battery device 61 is disposed on a rear end portion of the revolving frame 31. As illustrated in FIG. 4, the battery device 61 is disposed at substantially the center of the revolving frame 31 in the vehicle width direction. The vehicle width direction is synonymous with the left-right direction. The battery device 61 supplies the inverter 63 with DC electric power.

The battery device 61 includes a plurality of battery packs layered in the up-down direction, and a water jacket in which a heat transfer fluid circulates. A plurality of batteries are arranged within each of the battery packs. As the heat transfer fluid circulates within the water jacket, each of the batteries is kept at an appropriate temperature range (for example, 20 °C to 35 °C). The battery device 61 also functions as a counter weight included in a typical hydraulic excavator.

The BTMS 62 is disposed on the battery device 61. The BTMS 62 manages temperatures of the battery device 61. The BTMS 62 supplies the water jacket of the battery device 61 with the heat transfer fluid for cooling or heating the battery device 61.

The inverter 63 is disposed in front of the battery device 61. The inverter 63 converts DC electric power supplied from the battery device 61 into AC electric power having a desired frequency. The inverter 63 is electrically coupled to the electric motor 64 through a high-voltage cable 68. The inverter 63 supplies the electric motor 64 with AC electric power through the high-voltage cable 68. In the present embodiment, two high-voltage cables 68 are used. However, the number of high-voltage cables 68 can be changed appropriately.

On the side end portion (right end portion in the present embodiment) of the revolving frame 31, the electric motor 64 is disposed in front of the hydraulic pump 65 and behind the hydraulic oil tank 66.

As illustrated in FIGS. 3 and 4, the front end of the electric motor 64 is disposed more rearward than the revolving center Ax of the upper revolving body 3. The line La indicating the position of the front end of the electric motor 64 in the front-rear direction is spaced apart rearward by a distance Da from the revolving center Ax of the upper revolving body 3. There is no particular limitation as to the distance Da, and it is possible to set it to a value greater than 0 on an as-necessary basis.

The electric motor 64 is electrically coupled to the inverter 63 through the high-voltage cable 68. The electric motor 64 is driven with AC electric power supplied from the inverter 63 through the high-voltage cable 68. Specifically, the electric motor 64 rotates a drive shaft 64a disposed along the front-rear direction. As illustrated in FIGS. 3 and 4, the drive shaft 64a is connected to a rotating shaft 65a of the hydraulic pump 65 that will be described later. The electric motor 64 drives the hydraulic pump 65 with the rotation of the drive shaft 64a.

The electric motor 64 is fixed to the hydraulic pump 65 with a coupling 69. The coupling 69 is formed into an annular shape. The coupling 69 is connected to each of the electric motor 64 and the hydraulic pump 65.

On the side end portion (right end portion in the present embodiment) of the revolving frame 31, the hydraulic pump 65 is disposed behind the electric motor 64.

The hydraulic pump 65 includes the rotating shaft 65a disposed along the front-rear direction. The shaft center of the rotating shaft 65a of the hydraulic pump 65 substantially matches the shaft center of the drive shaft 64a of the electric motor 64. Within the coupling 69, the rotating shaft 65a of the hydraulic pump 65 is connected to the drive shaft 64a of the electric motor 64. Note that the rotating shaft 65a of the hydraulic pump 65 may be connected to the drive shaft 64a of the electric motor 64 through an intermediate member.

The hydraulic pump 65 is coupled to the hydraulic oil tank 66 through a suction pipe 70. The suction pipe 70 is a pipe configured to guide hydraulic oil from the hydraulic oil tank 66 to the hydraulic pump 65. The hydraulic pump 65 is coupled to the hydraulic valve 67 through a supply pipe 71. The supply pipe 71 is a pipe configured to guide hydraulic oil from the hydraulic pump 65 to the hydraulic valve 67. In the present embodiment, two supply pipes 71 are used. However, the number of the supply pipes 71 can be changed appropriately.

As the rotating shaft 65a of the hydraulic pump 65 rotates in association with the rotation of the drive shaft 64a of the electric motor 64, the hydraulic pump 65 draws hydraulic oil from the suction pipe 70, and discharges hydraulic oil to the supply pipe 71. With this configuration, hydraulic oil is supplied from the hydraulic oil tank 66 to the hydraulic valve 67.

On the side end portion (right end portion in the present embodiment) of the revolving frame 31, the hydraulic oil tank 66 is disposed in front of the electric motor 64. The hydraulic oil tank 66 is a container having a box shape. The hydraulic oil tank 66 holds hydraulic oil therein.

The hydraulic oil tank 66 supplies hydraulic oil through the suction pipe 70 to the hydraulic pump 65. The front end portion of the suction pipe 70 is coupled to the lower end portion of the hydraulic oil tank 66. The hydraulic oil held in the hydraulic oil tank 66 passes through the suction pipe 70 and is drawn by the hydraulic pump 65.

On the side end portion (right end portion in the present embodiment) of the revolving frame 31, the hydraulic valve 67 is disposed in front of the hydraulic oil tank 66. The hydraulic valve 67 is supplied with the hydraulic oil discharged from the hydraulic pump 65 through the supply pipe 71. The hydraulic valve 67 is configured to supply the hydraulic oil to the work-implement driving unit 41 of the work implement unit 4. With this configuration, the work implement 40 of the work implement unit 4 is driven.

The high-voltage cable 68 is coupled to the inverter 63 and the electric motor 64. The high-voltage cable 68 supplies the electric motor 64 with electrical power supplied through the inverter 63 from the battery device 61.

As illustrated in FIG. 4, the high-voltage cable 68 extends from the electric motor 64 toward the center in the vehicle width direction. In the present embodiment, the electric motor 64 is disposed on the right end portion of the revolving frame 31. Thus, the high-voltage cable 68 extends leftward from the electric motor 64 toward the inverter 63. In FIG. 4, the center in the vehicle width direction is indicated by the line Lb passing through the center of the revolving frame 31 in the vehicle width direction.

As illustrated in FIG. 4, the high-voltage cable 68 is disposed on the center side in the vehicle width direction relative to the outer edge, in the vehicle width direction, of the electric motor 64 in a top view. In the present embodiment, the electric motor 64 is disposed on the right end portion of the revolving frame 31, and hence, the high-voltage cable 68 is disposed on the center side in the vehicle width direction relative to the outer edge at the right side of the electric motor 64. The outer edge, in the vehicle width direction, of the electric motor 64 represents an area of the electric motor 64 that is opposed to the vehicle body cover 32 (not illustrated in FIG. 4, and see FIG. 1) in a top view. In FIG. 4, the outer edge at the right side of the electric motor 64 is indicated by the line Lc.

The suction pipe 70 is coupled to the hydraulic pump 65 and the hydraulic oil tank 66. As illustrated in FIG. 4, the suction pipe 70 extends along the drive shaft 64a of the electric motor 64. In the present embodiment, the drive shaft 64a of the electric motor 64 extends along the front-rear direction, and hence, the suction pipe 70 also extends along the front-rear direction.

Here, as illustrated in FIG. 4, the suction pipe 70 overlaps with the electric motor 64 in a top view. The suction pipe 70 passes through the inside of the electric motor 64 in a top view. The suction pipe 70 does not stick out to the left or right of the electric motor 64. In the present embodiment, the suction pipe 70 is disposed below the electric motor 64. Thus, the suction pipe 70 extends in the front-rear direction between the electric motor 64 and the revolving frame 31.

As illustrated in FIG. 4, the suction pipe 70 includes a horizontal pipe 70a and a vertical pipe 70b. The horizontal pipe 70a extends along the horizontal direction (front-rear direction in the present embodiment) and below the electric motor 64 and the hydraulic pump 65. The vertical pipe 70b extends along the vertical direction and below the hydraulic pump 65. The front end portion of the horizontal pipe 70a is coupled to the lower end portion of the hydraulic oil tank 66. The rear end portion of the horizontal pipe 70a is coupled to the lower end portion of the vertical pipe 70b. The upper end portion of the vertical pipe 70b is coupled to the lower surface of the hydraulic pump 65.

### Features

(1) In the electric excavator 1, the hydraulic pump 65, the electric motor 64, and the hydraulic oil tank 66 are disposed on the right side end portion (one example of the side end portion) of the revolving frame 31 of the upper revolving body 3. The electric motor 64 is disposed in front of the hydraulic pump 65 and behind the hydraulic oil tank 66.

Thus, the electric motor 64 is disposed forward of the hydraulic pump 65. This makes it possible to prevent the electric motor 64 from being affected even if an obstacle comes into contact with the right rear end portion of the upper revolving body 3 that is revolving leftward. In addition, the electric motor 64 is disposed behind the hydraulic oil tank 66, and thus the electric motor 64 is protected from being affected even if an obstacle comes into contact with the right front end portion of the upper revolving body 3 that is revolving rightward. Thus, it is possible to protect the electric motor 64.

(2) The front end of the electric motor 64 is disposed behind the revolving center Ax of the upper revolving body 3. This makes it possible to prevent the electric motor 64 from excessively sticking out frontward. Thus, it is possible to further prevent the electric motor 64 from being affected even if an obstacle comes into contact with the right front end portion of the upper revolving body 3 that is revolving rightward.

(3) In the electric excavator 1, the hydraulic valve 67 is disposed in front of the hydraulic oil tank 66. This makes it possible to prevent the electric motor 64 from excessively sticking out frontward. Thus, it is possible to further prevent the electric motor 64 from being affected even if an obstacle comes into contact with the right front end portion of the upper revolving body 3 that is revolving rightward.

(4) In the electric excavator 1, the high-voltage cable 68 extends from the electric motor 64 toward the center in the vehicle width direction. This makes it easy to dispose the high-voltage cable 68 at the inner side of the electric motor 64 in the vehicle width direction. Thus, even if an obstacle comes into contact with the upper revolving body 3 that is revolving, it is possible to prevent the high-voltage cable 68 from being affected.

(5) In the electric excavator 1, the high-voltage cable 68 is disposed on the center side in the vehicle width direction relative to the outer edge (right-side outer edge in the present embodiment), in the vehicle width direction, of the electric motor 64 in a top view. In this manner, since the high-voltage cable 68 is disposed at the inner side than the electric motor 64, it is possible to prevent the high-voltage cable 68 from being affected even if an obstacle comes into contact with the upper revolving body 3 that is revolving.

(6) In the electric excavator 1, the suction pipe 70 overlaps with the electric motor 64 in a top view. This makes it possible to reduce the space in the vehicle width direction necessary to dispose the electric motor 64 and the suction pipe 70 together, as compared with a case where the suction pipe 70 does not overlap with the electric motor 64.

(7) In the electric excavator 1, the suction pipe 70 is disposed below the electric motor 64. This makes it easy to couple the front end portion of the suction pipe 70 to the lower end portion of the hydraulic oil tank 66. Thus, it is possible to draw, into the suction pipe 70, hydraulic oil that does not contain air bubbles from the hydraulic oil tank 66.

### Modification Example of Embodiment

These are descriptions of the embodiment according to the present invention. However, the present invention is not limited to those, and various modifications are possible as appropriate within a range that does not depart from the technical ideas of the invention.

### First Modification Example

In the embodiment described above, the hydraulic pump 65, the electric motor 64, and the hydraulic oil tank 66 are disposed on the right side end portion of the revolving frame 31. However, these units may be disposed on the left side end portion of the revolving frame 31. In this case, the cab 5 is disposed on the right side end portion of the revolving frame 31.

### Second Modification Example

In the embodiment described above, the front end of the electric motor 64 is disposed behind the revolving center Ax of the upper revolving body 3. However, this front end may overlap with the revolving center Ax or may be disposed in front of the revolving center Ax.

### Third Modification Example

In the embodiment described above, the hydraulic valve 67 is disposed in front of the hydraulic oil tank 66. However, the configuration is not limited thereto. The position of the hydraulic valve 67 can be changed appropriately.

### Fourth Modification Example

In the embodiment described above, the high-voltage cable 68 extends from the electric motor 64 toward the center in the vehicle width direction. However, the configuration is not limited thereto. For example, the high-voltage cable 68 may extend frontward or the rearward from the electric motor 64.

### Fifth Modification Example

In the embodiment described above, the high-voltage cable 68 is disposed, in a top view, on the center side in the vehicle width direction relative to the outer edge, in the vehicle width direction, of the electric motor 64. However, the configuration is not limited thereto. For example, only a portion of the high-voltage cable 68 may be disposed at the outer side in the vehicle width direction than the outer edge, in the vehicle width direction, of the electric motor 64.

### Sixth Modification Example

In the embodiment described above, the suction pipe 70 is positioned so as to overlap the electric motor 64 in a top view. However, the configuration is not limited to this. Only a portion of the suction pipe 70 may not overlap with the electric motor 64.

### Seventh Modification Example

In the embodiment described above, the suction pipe 70 is disposed below the electric motor 64. However, the pipe may be disposed on the electric motor 64.

### Eighth Modification Example

The embodiment described above describes the electric excavator as one example of the electric work machine. However, the electric work machine is not limited thereto. It is only necessary that the electric work machine is a machine in which the work implement is operated with electrical power of a battery device. Such an electric work machine includes an electric wheel loader, a motor grader, or the like.

### Supplementary Note 1

An electric work machine according to the present disclosure includes: a lower traveling body; an upper revolving body configured to revolve relative to the lower traveling body; a hydraulic pump configured to discharge hydraulic oil; an electric motor configured to drive the hydraulic pump; and a hydraulic oil tank configured to supply hydraulic oil to the hydraulic pump, in which the hydraulic pump, the electric motor, and the hydraulic oil tank are disposed on a side end portion of the upper revolving body, and the electric motor is disposed in front of the hydraulic pump and behind the hydraulic oil tank.

### Supplementary Note 2

The electric work machine according to Supplementary Note 1, in which a front end of the electric motor is disposed behind a revolving center of the upper revolving body.

### Supplementary Note 3

The electric work machine according to Supplementary Note 1 or 2 further including: a hydraulic valve to which hydraulic oil is supplied from the hydraulic pump, in which the hydraulic valve is disposed in front of the hydraulic oil tank.

### Supplementary Note 4

The electric work machine according to any one of Supplementary Notes 1 to 3 further including a high-voltage cable coupled to the electric motor, in which the high-voltage cable extends from the electric motor toward a center in a vehicle width direction.

### Supplementary Note 5

The electric work machine according to any one of Supplementary Notes 1 to 4 further including a high-voltage cable coupled to the electric motor, in which in a top view, the high-voltage cable is disposed on a center side in a vehicle width direction relative to an outer edge, in the vehicle width direction, of the electric motor.

### Supplementary Note 6

The electric work machine according to any one of Supplementary Notes 1 to 5 further including a suction pipe coupled to the hydraulic pump and the hydraulic oil tank and extending along an output shaft of the electric motor, in which in a top view, the suction pipe is positioned so as to overlap the electric motor.

### Supplementary Note 7

The electric work machine according to Supplementary Note 6, in which the suction pipe is disposed below the electric motor.

### REFERENCE SIGNS LIST

1 Electric excavator, 2 Lower traveling body, 3 Upper revolving body, 31 Revolving frame, 32 Vehicle body cover, 4 Work implement unit, 5 Cab, 61 Battery device, 62 BTMS, 63 Inverter, 64 Electric motor, 65 Hydraulic pump, 66 Hydraulic oil tank, 67 Hydraulic valve, 68 High-voltage cable, 69 Coupling, 70 Suction pipe, 80 Distribution Board

1. An electric work machine, comprising:
a lower traveling body;
an upper revolving body configured to revolve relative to the lower traveling body;
a hydraulic pump configured to discharge hydraulic oil;
an electric motor configured to drive the hydraulic pump; and
a hydraulic oil tank configured to supply hydraulic oil to the hydraulic pump,
the hydraulic pump, the electric motor, and the hydraulic oil tank being disposed on a side end portion of the upper revolving body, and
the electric motor being disposed in front of the hydraulic pump and behind the hydraulic oil tank.

2. The electric work machine according to claim 1, wherein
a front end of the electric motor is disposed behind a revolving center of the upper revolving body.

3. The electric work machine according to claim 1, further comprising:
a hydraulic valve to which hydraulic oil is supplied from the hydraulic pump,
the hydraulic valve being disposed in front of the hydraulic oil tank.

4. The electric work machine according to claim 1, further comprising:
a high-voltage cable coupled to the electric motor,
the high-voltage cable extending from the electric motor toward a center in a vehicle width direction.

5. The electric work machine according to claim 1, further comprising:
a high-voltage cable coupled to the electric motor,
in a top view, the high-voltage cable being disposed on a center side in a vehicle width direction relative to an outer edge, in the vehicle width direction, of the electric motor.

6. The electric work machine according to claim 1, further comprising:
a suction pipe coupled to the hydraulic pump and the hydraulic oil tank, the suction pipe extending along an output shaft of the electric motor,
in a top view, the suction pipe being positioned so as to overlaps the electric motor.

7. The electric work machine according to claim 6, wherein
the suction pipe is disposed below the electric motor.
